(19) United States
(12) Patent Application Publication
(10) Pub. No.: US 2011/0125611 A1
(43) Pub. Date: May 26, 2011

(54) Optimized Electronic Commerce Transactions

(75) Inventors: Karl Perron, Cincinnati, OH (US); Tony L. Shipley, Cincinnati, OH (US)

(73) Assignee: iStatus LLC., Cincinnati, OH (US)

(21) Appl. No.: 12/954,353

(22) Filed: Nov. 24, 2010

Related U.S. Application Data
(60) Provisional application No. 61/264,123, filed on Nov. 24, 2009.

(51) Int. Cl. G06Q 30/00

(52) U.S. Cl. 705/27.1; 705/26.1

(57) ABSTRACT

An electronic commerce system can facilitate various types of transactions, including business to business transactions, business to consumer transaction, business to business to consumer transaction, as well as other types of transactions. By combining such an electronic commerce system with invitation, and social networking technology, it is possible to create a system which will automatically grow and bring value to all its users as it processes transactions.

### CROSS REFERENCE TO RELATED APPLICATIONS

This application is related to, and claims the benefit of, co-pending provisional patent application 61/264,123, filed on Nov. 24, 2009, having the same title and inventors as listed above. The disclosure of that application is hereby incorporated by reference in its entirety.

### FIELD OF THE INVENTION

The present invention relates, in general, to interactive networks or internet applications and, in particular, to optimized electronic commerce systems and methods that facilitate transactional exchanges between two or more parties.

### BACKGROUND

Business-to-Business (“B2B”) Commerce plays a vital role in the day-to-day operations of any modern business. Due to this importance, B2B Commerce continues to evolve as new marketing and communication channels are created through technological advancements. For instance, the Internet has provided modern businesses with the ability to utilize B2B systems to create virtual storefronts, electronically publish and exchange catalogs with potential buyers and sellers of goods, and electronically manage orders and order fulfillment. However, such B2B systems are typically too cost-prohibitive and too complex for most businesses to implement. As a result, many businesses cannot benefit from the added benefits of B2B systems such as a reduction in duplicate data entry and capture, a reduction in paper handling, a reduction in the use of incorrect business forms, an increase in financial compliance and auditing capabilities, and faster period-end closing and reporting, among others.

Businesses that either cannot afford a modern B2B system, or lack the expertise to implement one, are generally only left with the option of conducting B2B commerce manually, which is highly inefficient. For instance, a business without a modern B2B system must often either mail a hard copy of a catalog, or transmit an electronic version to one or more prospective buyers. Additionally, actual salespeople are often required to personally make calls to prospective buyers in order to generate business. When placing orders, buyers and sellers must often fax or email quotes and orders back and forth multiple times. Payments are typically made by check. These are just some of the many inefficiencies associated with conducting B2B commerce manually.

Aside from the cost and complexity, conventional B2B systems also suffer from a number of inherent weaknesses, which negatively affect even businesses which do have access to B2B commerce systems. For instance, in a supply chain based on transactions using even the most advanced B2B systems of the prior art, suppliers of goods often have very little visibility on how their products are actually consumed or used beyond the distributer. As such, conventional B2B systems fail to provide suppliers with feedback or reputational data from entities along the supply chain. Conventional B2B systems also fail to provide distributers with the ability to automatically generate custom quotes and electronic commerce stores for their customers. For example, conventional B2B systems often require distributors to manually submit product substitutions, or an incomplete quote, when a customer requests a quote for non-standard goods.

### SUMMARY

Disclosed herein is technology which can be used in a variety of settings, including facilitating electronic commerce transactions between businesses and consumers, and facilitating the set up and maintenance of electronic commerce storefronts where various transactions can be initiated. For example, the disclosed technology can be used to implement a system comprising an electronic commerce system, wherein the electronic commerce system is configured to facilitate interactions between one or more buyers and one or more sellers, and wherein the electronic commerce system is configured to allow one or more users of the electronic commerce system to provide one or more invitations to enter into transactions with, or create an account in, the electronic commerce system. Parallel methods are also possible, and might include steps such as logging into an electronic commerce system, sending an invitation from a first user to an entity to participate in an interaction via the electronic commerce system; and storing data associating the first user and the entity in the electronic commerce system based on the invitation.

Of course, the disclosed technology is not limited to the invitation-based implementations described above. For example, aspects of the disclosed technology could be used to perform a method comprising adding an interface application to a network location, wherein the interface application is configured to, in response to a user accessing the network location using a user computer, send a request for a set of storefront data to a server located remotely from the user computer. Other steps in such a method could include, via an interface provided by the server, selecting a store for publication, and sending a message to the server located remotely from the user computer indicating that the store should be published at the network location. By performing such a method, it is possible that the store can be made accessible such that purchases from the store can be made by the user at the network location by performing steps capable of completion by a single individual in less than ten minutes.

Other methods, machines, articles of manufacture, and computer readable media could also be implemented based on the disclosure set forth herein. Accordingly, the summary set forth above should be understood as being illustrative only, and not limiting.

### BRIEF DESCRIPTION OF THE DRAWINGS

The accompanying drawings incorporated in and forming a part of the specification illustrate aspects of various implementations of the inventors' technology. Of course, it should be understood that the inventors' technology is not limited to the precise arrangements shown. In the drawings:

FIG. 1 is a block diagram of an architecture for an electronic commerce system.

FIG. 2 is a block diagram of an electronic commerce system to facilitate B2B commerce transactions and interactions.

FIG. 3 is a block diagram of an electronic commerce system that utilizes social or business connections to facilitate B2B commerce transactions and interactions.

FIG. 4 is a block diagram of an electronic commerce system that utilizes web-based technologies to facilitate B2B commerce transactions and interactions.

FIGS. 5A through 5L illustrate an exemplary sitemap which can be utilized in conjunction with an electronic commerce system to facilitate B2B commerce transactions and interactions.

FIG. 6 illustrates a process for making an electronic commerce transaction possible.

FIG. 7 illustrates communications which could take place in executing an electronic commerce transaction.

FIG. 8 illustrates an architecture which would be used to support electronic commerce transactions.

FIG. 9 illustrates a data structure which can be used to represent a product.

FIG. 10 illustrates a data structure which could be used to organize products into product sets.

FIG. 11 illustrates a sequence of events which could take place in creating and accepting a quote.

FIG. 12 illustrates interactions that could take place in fulfilling an order through an electronic commerce system.

FIG. 13 illustrates how sharing can take place using an electronic commerce system.

### DETAILED DESCRIPTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Using aspects of the following disclosure, a wide variety of tasks which would previously have been impossible or would have required substantial expenditures of time and resources can be simplified to the extent that they can be completed in a matter of minutes by organizations or individuals having little or no sophisticated technical knowledge. To illustrate this, and to explain the inventors' technology, a number of concrete applications of that technology are set forth herein. While, based on this disclosure, one of ordinary skill in the art could implement the inventors' technology without undue experimentation, and could do so to solve a variety of technical problems and satisfy a number of long-felt but unmet needs in the art, it should be understood that the inventors' technology is not limited to being implemented in the specific forms or context set forth herein, and that it could be beneficially applied in a variety of other settings, using implementations which diverge from those explicitly set forth in a variety of fashions. Accordingly, the disclosure set forth herein should be understood as being illustrative only, and not limiting.

As an example of how the inventors' technology can render trivial that which would previously have been possible only with the expenditure of substantial time and resources, consider the task faced by a business which wishes to add a new sales channel for its products, such as by making products which are already available through its own web site available through one or more third party environments (e.g., social networking sites such as Facebook or MySpace). Using the inventors' technology, a business' stores can be stored in a database maintained by a server accessible over a network such as the Internet. The information in such a database can include data used in initiating and completing transactions, such as what payment methods (e.g., PayPal, etc) are accepted for purchases at the store, what transportation methods (e.g., UPS, postal service, etc) are used to deliver products ordered at the store, how (and for which jurisdictions) taxes are collected for purchases at the store, and other appropriate data. Additionally, in some embodiments, the information maintained in such a database can also include what front ends the collection of products making up the store should be offered through. Using such an embodiment, rather than having to perform tasks such as coding a new e-commerce front end and integrating it with a company's back end inventory management software (assuming such exists), a new store can be created simply by sending an instruction to the server maintaining the database that the seller wishes for a store to be available through a new environment, and adding a pre-programmed application to the environment the store should be made available through.

To take the example of Facebook, this process could be completed by a single person in less than 10 minutes by logging into Facebook, searching for the name of the storefront application using Facebook's search tool, clicking on the “add application” button provided by Facebook, logging into the server maintaining the database with the store, selecting the store to be added to Facebook, and clicking an “Add to Facebook” button (or other appropriate tool). As a result of this sequence of events, when a potential customer visits the Facebook page of the business and selects the tab for the storefront, the application would send a request to the server maintaining the database which would respond by sending the store to the computer of the consumer. The consumer could then make purchases through the store which would be processed by the server maintaining the database.

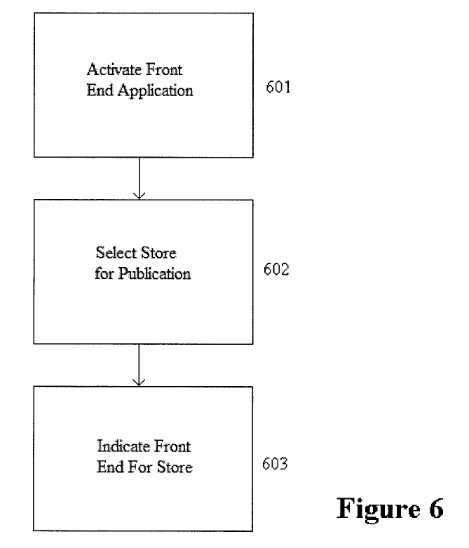

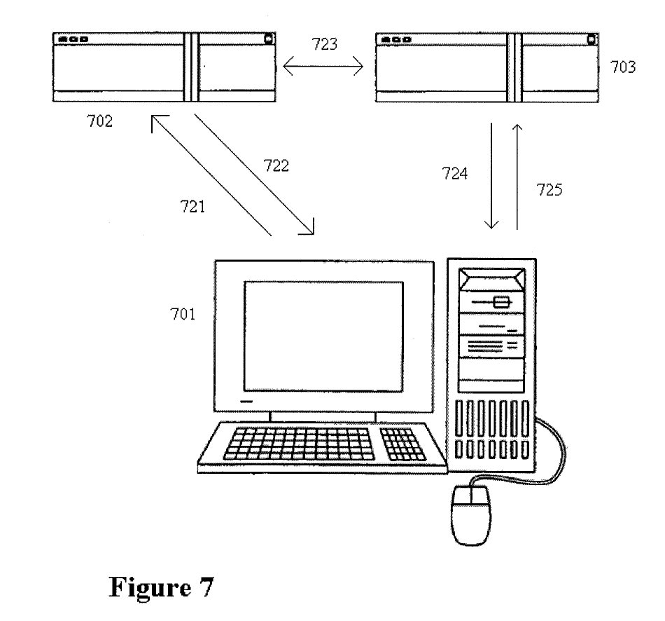

The process of making such a transaction possible is illustrated in FIG. 6. In FIG. 6, the step of activating the front end application [601] corresponds to the step of selecting and adding the storefront application in the discussion above of adding a new store to a Facebook page. The next two steps, selecting a store for publication [602], and indicating the front end for the store [603], correspond to the user indicating what store should be added to the Facebook page, and then clicking an “Add to Facebook” button or other appropriate control. Once this process is complete, when a consumer visits the business' Facebook site, he or she could engage in a transaction using the communications shown in FIG. 7. This would start with the consumer sending a message [721] via his or her computer [701] to the Facebook server [702] asking to see the business' Facebook page. This would result in the Facebook server [702] sending back the business' page [722], and, because the business had added the storefront application to the page, engaging in a validation communication [723] with the server maintaining the database [703]. Once the validation was complete, the server maintaining the database [703] could send the storefront data [724] to the consumer's computer [701]. This data could include pictures of the items the business had included in the store, controls to add those items to a shopping cart (or to purchase them without an intermediary shopping cart step, if such one click purchasing is included and enabled in the particular implementation), or other items, such as controls that could allow the consumer to post reviews of the items, or to add comments about the items to his or her own Facebook profile. Once the storefront data is received at the consumer's computer [701], he or she could use the controls included in that data to communicate directly [725] with the server maintaining the database [703] to order items from the store, which orders would be fulfilled by the server [703] just as any other electronic commerce transaction.

Of course, it should be understood that the example given above for adding a store to Facebook, and the particular steps and communications described with reference to FIGS. 6 and 7 are intended to be illustrative only, and not limiting. As will be apparent to those of ordinary skill in the art, the same techniques can be applied in other contexts that Facebook, such as other social networks (e.g., MySpace), or in other pages entirely, such as the home page for a business maintaining a store. It should also be understood that, while the disclosure above focused on adding a storefront to a single new environment (e.g., Facebook), the same process could be used to create multiple new storefronts (e.g., one on Facebook, one on MySpace, which could be set up at once by, for example, using a check box on each desired front end) which, because they are all driven from the same back end database would stay synchronized with one another in much the same way as a syndicated news feed. Further, the particular order of steps illustrated is also not intended to imply that the steps listed must be performed in precisely that order. For example, in some implementations, rather than beginning by adding a storefront application to a page, a business might first select a store to publish through a particular channel, and subsequently add the storefront application to the page where the store will appear.

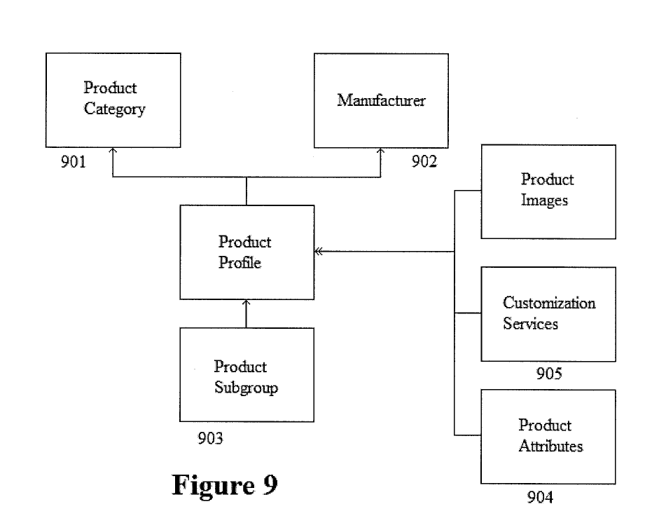

In terms of how information could be stored to facilitate the types interactions described above, there is a variety of different approaches that could be used in different implementations. For example, in some implementations, information used to support stores as described above, as well (potentially) as other functionality could be stored in a database in an object oriented format. In an implementation using such an object oriented approach, the products which can be made available in a store can be represented by data structures such as shown in FIG. 9.

In FIG. 9, the product category component [901] represents a category which can be assigned by a supplier group within an organization, and can have attributes such as a name and description for the category, and an image file which can be used to represent the category, such as in the case where an electronic commerce system allows products to be searched on a category level. The manufacturer component [902] can represent the manufacturer of a particular product, and can include information such as the name of the manufacturer, and also (if applicable) an ID of the manufacturer's account in the electronic commerce system. The product subgroup component [903] can indicate the number of variations available on a core product. For example, if a golf shirt is available in three colors and four sizes, then it could have twelve (3×4) subgroups. The individual subgroups can be stored as objects or tables (in the event the information is stored in a relational database) having data such as a stock keeping unit, a wholesale price, a cost, a suggested retail price, and an attribute list of the attributes which make that subgroup unique. In terms of the attributes that define a subgroup, it should be understood that, while those attributes are illustrated as a component of a product [904], in some implementations attributes and their associated options (e.g., a color attribute with available colors as options) could be defined once then used for multiple products. For example, multiple products in a product category of clothing might reuse a product attribute of color, to reflect that a store sells clothing using certain pre-defined colors. The customization services component [905] in FIG. 9 indicates data that can be stored to reflect options that customers might define at the time of purchase (for example, if a customer wants a particular logo added to a piece of apparel).

In addition to maintaining objects such as shown in FIG. 9 in a database, some implementations might also provide tools that could be used to actually define those objects (or components of the same). For example, consider the case of a customization component [905]. In some implementations, when a user wishes to add such a component to a product, he or she could be walked through a process including steps such as: 1) the user enters the basic information for the service, including its name, description, cost and price (as applicable); 2) the user identifies the tools a customer will use to define a customization service (e.g., radio buttons, text fields, checkboxes, and combo boxes); and 3) the user will specify if customization is necessary for a particular item. As another example, in some implementations, there could be features to facilitate or automate the creation of subgroups and related data. To illustrate, in the golf shirt example provided previously, once the default identifier and attributes for a product had been entered, an electronic commerce system could automatically generate a list of potential subgroups, along with default SKUs (e.g., GSHIRT100-RED-S; GSHIRT100-RED-M; etc), which a user could then modify or delete as desired.

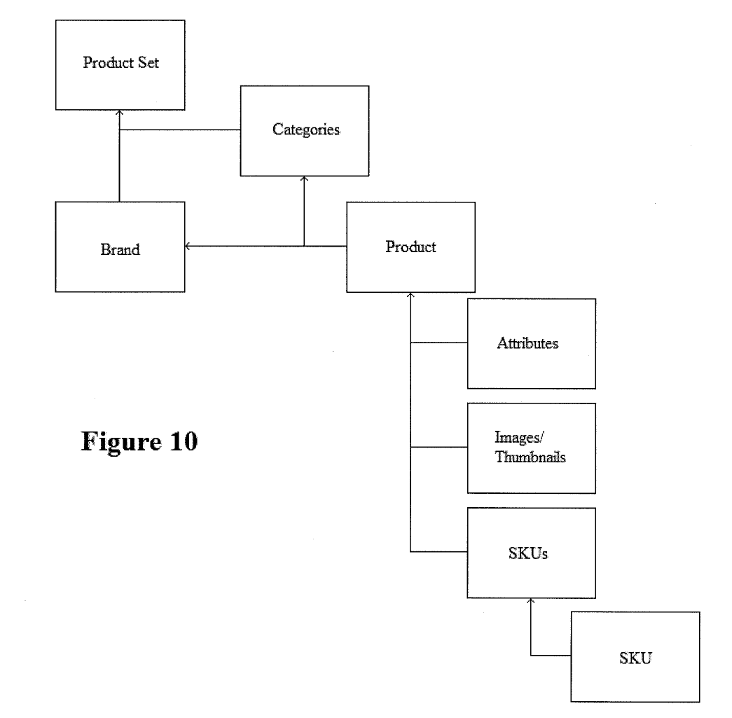

Of course, in various implementations, other types of objects and data structures can also be maintained. For example, FIG. 10 shows a data structure which could be used to organize products into product sets, which an entity such as a manufacturer or a supplier could use to manage their data. Similar objects, such as catalogs, which could be used to manage pricing and selection data (e.g., minimum order quantity, unit of measure) could be used as well. These catalogs can, in some implementations, be used to create catalog feeds which resellers can use to integrate supplier information into their own catalogs. For example, a reseller could be supplied with a catalog feed for a supplier, and then extend it by adding their own information, such as a new product ID, SKU, special notes, price, or new units of measure. The catalog feed could then be used to create a unified store (which could also be stored as an object in the database) and presented to customers as described previously.

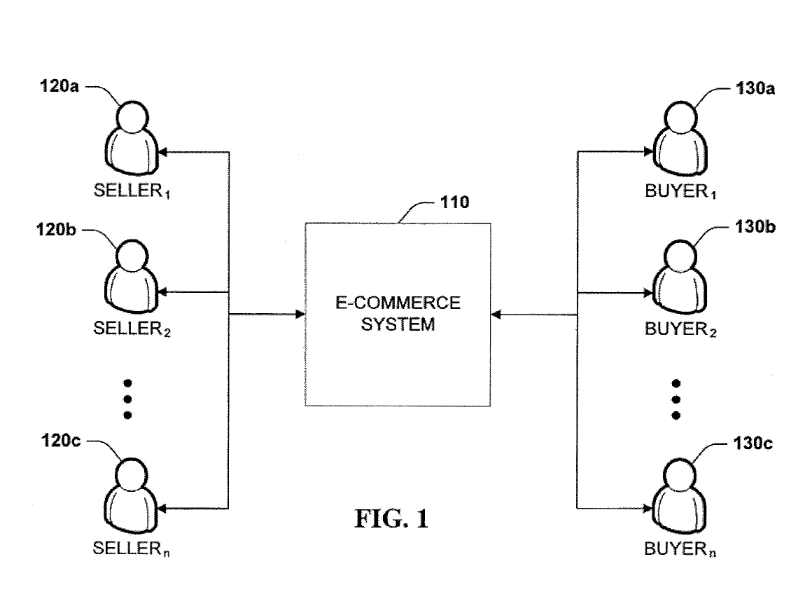

As will be understood by those of ordinary skill in the art in light of the disclosure above, the inventors' technology is not limited to the easy creation of new electronic commerce storefronts. For example, data such as described above could be used to power a system which provides a back end platform for a variety of front end objectives. To illustrate, consider FIGS. 1-4, 11 and 12 which, along with the following disclosure, describes how the inventors' technology can be used to implement a general purpose electronic commerce platform, as well as various uses which such a platform could be put to, including powering business and transaction centric social networks.

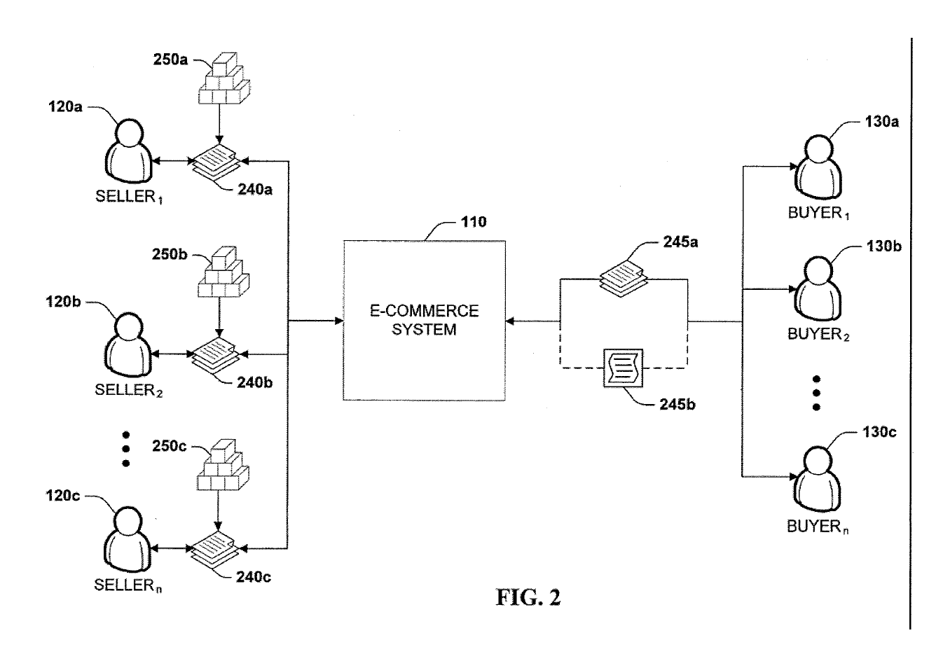

Referring initially to FIG. 1, that figure depicts an architecture in which an electronic commerce system [110] can be used to facilitate transactions and interactions between two or more parties (e.g., Business to Business (“B2B”), Business to Consumer (“B2C”), Business to Business to Consumer (“B2B2C”) etc). As indicated in FIG. 2, one or more sellers [120a-c] can offer a variety of products [250a-c] (and/or services, depending on the requirements of a particular seller and the specifics of the implementation used by that seller) for sale via an electronic commerce system [110]. To do this, the one or more sellers [120a-c] can be provided with a variety of tools to support making the electronic commerce system [110] aware of the products [250a-c] the sellers [120a-c] wish to make available. For example, the sellers [120a-c] can be provided with utilities (e.g., wizards, data mapping applications, etc) which can convert the sellers' existing inventory information into catalogs [240a-c] in a form suitable for the electronic commerce system [110], which can then be uploaded to the system. Similarly, in some implementations, the electronic commerce system [110] could provide an interface designed to allow the sellers to provide information directly, such as by allowing the sellers to upload an electronic product listing in the form of a Comma-Separated Value (“.csv”) file, spreadsheet, Extensible Markup Language (“XML”) file, and/or other manners which might be appropriate based on the systems of the seller. It is also possible that an electronic commerce system [110] could include features which would facilitate of the creation of a catalog by sellers. For example, an electronic commerce system [110] could comprise a repository of product information such as described previously, which might include Universal Product Codes (“UPC”), seller assigned QR codes, product images, product dimensions, product weights, product descriptions and/or other types of product information as appropriate. This information could then be used by sellers to help generate customized electronic catalogs, or by buyers to search for products, or to search for sellers who can provide products (e.g., a buyer could enter a seller defined QR code that was distributed in an advertisement, and the electronic commerce system would inform the buyer of the appropriate seller, and could also automatically generate an invitation to the seller to make an offer to the buyer and/or join the buyer's business network).

However the information about products (and/or services) [250a-c] is provided to the electronic commerce system [110], once it is available to the system [110], the system [110] can function to provide it to one or more buyers [130a-c]. For example, an electronic commerce system [110] can be implemented to distribute a copy [245a] of the one or more generated catalogs [240a-c] as integrated documents, such as PDFs, movies, links to virtual storefronts maintained on a website (which could itself be maintained as part of the electronic commerce system [110], or could be storefronts on third party sites such as Facebook, as described previously), or in other appropriate formats depending on the capabilities of the individual buyers [130a-c]. Additionally or alternatively, the electronic commerce system [110] can distribute a catalog feed [245b] to the one or more buyers [130a-c]. This catalog feed [245b] can then be displayed in various front end interfaces. Indeed, in some implementations, the electronic commerce system [110] could support the ability for buyers to augment data from the catalog feed [245b] with buyer-specific information without overwriting information associated with the originally generated catalog [240a-c]. This could be used for a variety of purposes, such as facilitating buyers [130a-c] in reselling one or more products [250a-c], and/or allowing the buyers [130a-c] to combine products from multiple sellers into a single convenient virtual storefront.

In different implementations, a variety of data structures, organizations and relationships can be used to support architectures such as described above. For example, an electronic commerce system [110] could be implemented so that transactions are performed in an organization based framework. In such a case, there could be organization level accounts associated with entities which would actually be responsible for executing transactions entered into using the electronic commerce system [110] (e.g., manufacturers, wholesalers, distributors, retailers, etc). These organization level accounts could be associated with a number of accounts for individual buyers and/or sellers, which would represent the people/entities which would actually enter into the transactions, such as salespeople, purchasing agents, or other entities as might be appropriate for a particular organization. The organization accounts could also be associated with business information relevant to transactions executed through the electronic commerce system [110], such as, for example, billing/shipping/warehouse/location addresses, organizational hierarchies, enterprise resource planning (“ERP”) system information, individual user registration/management, payment preferences, shipping methods/rates, exchange rates, business contacts with other organizations, support groups, geographic locations and service areas, or other information of such as is beneficial in business intelligence or supply chain management systems.

In addition to storing information relevant to an organization, in implementations in which they are present, organization level accounts can also be used to provide tools which are helpful in managing the transactions and processes for the organization. For example, in some cases, administrators associated with organization accounts could be given access to tools which those administrators could use to set up accounts for their organization's individual buyers and/or sellers. Alternatively, in some implementations, rather than creating accounts through administrators, an electronic commerce system [110] could allow individuals (e.g., salespeople) to sign up for accounts which would then be associated with the buyer or seller's organization. In such a case, the electronic commerce system [110] could provide tools (e.g., input forms, wizards, etc) which would capture information relevant to the creation of the new user account, and then provide that captured information to an administrator for the organization associated with the user so that the administrator would have the opportunity to approve or reject the account before it was created. Also, in some implementations, an administrator might be provided with tools that could be used to modify information related to individual accounts within his or her organization. For example, for an account for a salesperson, the administrator might modify data associated with that account to indicate maximum discounts which that salesperson could offer, what types of products that salesperson was responsible for promoting, the maximum amount of various products a buyer could purchase, whether purchases or sales had to be routed to a supervisor before being completed, or other appropriate data.

Of course, it should be understood that, even in implementations with organization-based account structures, variations on those structures are possible. For example, an electronic commerce system [110] could be implemented to support cases where a user who would enter into a transaction and the entity which would be responsible for executing the transaction would be the same (e.g., supporting individual buyers who make purchases on their own personal accounts or credit cards). This could be done in a variety of ways, such as implementing degenerate organizations which include only a single user, by implementing umbrella organization data structures into which users who would be responsible for their own transactions could be grouped, by having separate account types for non-organizational users, or other approaches which are compatible with the processing of a particular electronic commerce system [110]. In some cases there could also be unique tools used for creating individual user accounts, such as interfaces which would request that an individual seeking to create an account provide information such as name, type, field of business, Internet domain name, or other information as might be appropriate in a particular situation (of course, similar information could also be captured when creating an account for a user who is associated with an organization).

Additionally, in some cases electronic commerce systems could include functionality which would support or encourage interactions with entities who are not associated with accounts of any kind. For example, in some cases, an electronic commerce system [110] could be implemented to include functionality which would allow or encourage existing users to invite new users to participate in the system. For example, an electronic commerce system [110] could be implemented to provide a mechanism for one or more previously registered users to upload address book information (e.g., in formats such as .csv, .xml, vCard (“.vcf” or “.vcard”), and/or other formats depending on how the user's existing address book information is stored), which might not only be associated with the account of the user who uploaded it, but might also (or alternatively) be used to generate invitations to the individuals in the address book to enter into transactions using, or to create accounts with, the electronic commerce system [110]. In such a case, if an invitation is sent to a user who does not already have an account, the electronic commerce system [110] might automatically prompt the invited user to register for an account on the system, which registration might be performed using tools such as wizards, input forms or other types of tools as described previously. Alternatively, in some cases, if an invitation is sent to a user who does not have an account (or an individual without an account seeks to use the electronic commerce system [110]), there could be support for creating stand-alone accounts which would have limited privileges (e.g., may not include authority to buy/sell products) to perform specific tasks, such as commenting on information accessed through the electronic commerce system [110], engaging in instant messaging sessions, or other purposes which might be appropriate in a given situation.

In addition to information described above, such as privilege and payment information, in some cases, an electronic commerce system [110] could store additional data and associate that data with individual users (or organization or other entities, depending on how accounts within that implementation are maintained). For example, in some implementations, accounts for individual buyers or sellers could be associated with information pertaining to the type(s) of products that a buyer or seller might be interested in (referred to, for convenience, as profile data). Such data can be captured in a variety of ways. For instance, this type of data can be captured during initial account generation, such as by being entered by the buyer or seller (or relevant administrator, etc) when the account was created. Additionally or alternatively, in examples of the electronic commerce system [110], profile data can comprise characteristics related to various transactions conducted via the system. By way of non-limiting example, BUYER₁ [130a] can be associated with an account, which is in turn associated with a profile. Initially, the characteristics associated with BUYER₁'s [130a] profile might only comprise certain basic information, such as the name and geographic location of BUYER₁ [130a]. However, the more that BUYER₁ [130a] conducts transactions and/or interacts with the electronic commerce system [110], additional characteristics can be associated with BUYER₁'s [130a] profile. Of course, in some implementations, there might also be tools provided which could allow users to add, modify, or delete profile data at various points after initial account generation, rather than simply relying on information gathered from transactions to update the profiles.

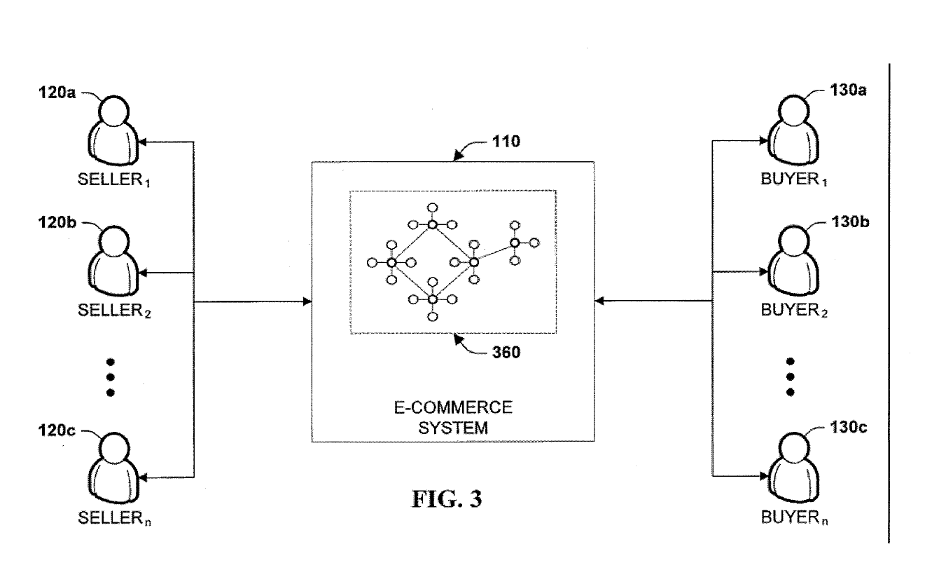

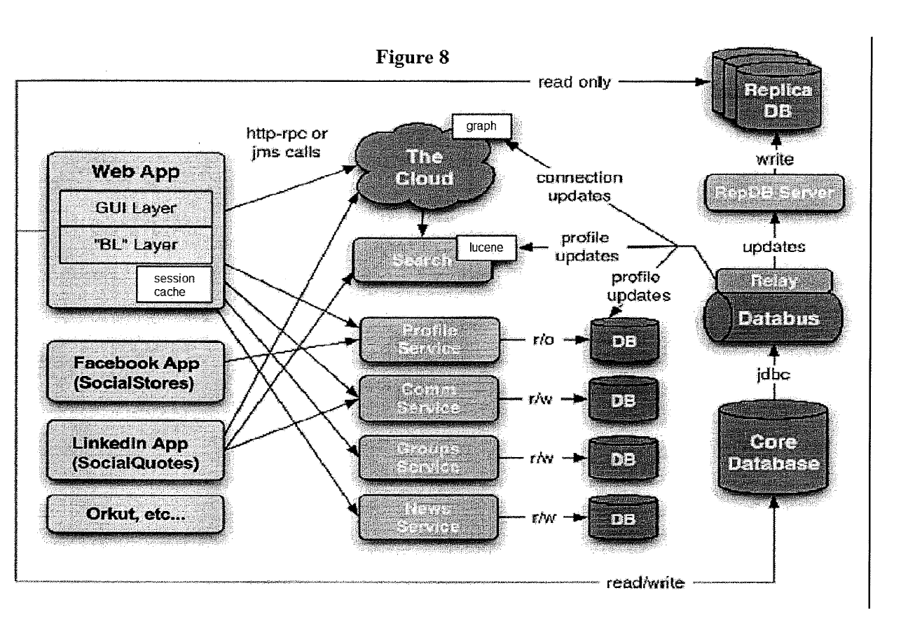

Other types and organizations of data (as well as supporting infrastructures, interfaces, and other tools) can be used in different implementations. For example, while the diagrams of FIGS. 1, 2 and 7 focused on relatively simple implementations where an electronic commerce system or various servers provided services to users, more complicated architectures, such as shown in FIG. 8, could also be deployed. However, whatever physical implementation is used in a particular case, based on the disclosure set forth herein, electronic commerce systems [110] could be implemented which would support a variety of beneficial features. For example, FIG. 3 illustrates an architecture in which an electronic commerce system [110] could be implemented to take advantage of social networking paradigms and connections between users and other entities to facilitate various types of transactions. For instance, one or more sellers [120a-c] can invite one or more buyers [130a-c] to create a virtual social and/or business connection [360] (e.g., an indication that a seller is an approved vendor for an organization, that a buyer should be shown offers for particular aspects of a seller's catalog, etc). By way of non-limiting example, BUYER₁ [130a] can invite SELLER₁ [120a] to create a virtual business connection, which, once created would result in the electronic commerce system [110] providing BUYER₁ [130a] with access to SELLER₁'s [120a] electronic catalog feed [245b] (as illustrated in FIG. 2) and purchase one or more products. In another non-limiting example, a similar reverse transaction is possible. For instance, SELLER₂ [120b] can invite BUYER₂ [130b] to create or accept a virtual business and/or social connection [360]. Once created, SELLER₂ [120b] might begin sending BUYER₂ [130b] an electronic catalog feed [245b] via the electronic commerce system [110]. BUYER₂ [130b] may then purchase products from SELLER₂ [120b] in a more efficient manner than possible with conventional B2B or B2C systems.

As disclosed, in implementations of the electronic commerce system [110], profile data can comprise information related to one or more B2B commerce transactions conducted via the system. In examples of the system [110], profile data can additionally comprise data associated with the virtual social and/or business connections [360] of one or more buyers [130a-c], sellers [120a-c], and/or individual users.

Of course, other beneficial functions could also potentially be supported in some electronic commerce systems [110] implemented based on this disclosure. For example, turning back to FIG. 2, an electronic commerce system [110] could potentially utilize profile and/or account data to provide users with information or data of particular relevance. For instance, based at least in part on profile and/or account data, the electronic commerce system [110] can determine the type of information that would be most relevant to a particular user. By way of non-limiting example, upon accessing system [110], BUYER₁ [130a] might be provided with a listing of products that are of particular interest based at least in part on the information from BUYER₁'s [130a] profile. Similarly, in some implementations, an electronic commerce system [110] may list only those products that are associated with the one or more sellers [120a-c] having a virtual social and/or business connection [360] (as illustrated in FIG. 3) with BUYER₁ [130a].

Similarly, in some implementations, an electronic commerce system [110] could provide (e.g., at user request) information and data to facilitate business decisions. For example, BUYER₁ [130a] could be provided with a listing of products of particular interest based in part on a geographic location provided by BUYER₁ [130a] during initial account registration. For instance, an electronic commerce system [110] might provide BUYER₁ [130a] with products offered by suppliers who conduct business in the same geographical area or region as BUYER₁ [130a] and/or which, based on the system's transaction data, are successful in the BUYER₁'s [130a] region. Similarly, in some cases, an electronic commerce system [110] could provide data or information that is particularly responsive to a request based in part on profile and/or account data associated with one or more buyers [130a-c], sellers [120a-c], and/or individual users. For instance, in a non-limiting example, BUYER₁ [130a] can utilize the electronic commerce system to search for one or more sellers [120a-c] that offer new or substitute products and services in the same geographical area or region, which have the same general size and customer base as the buyer, or have some other similar set of characteristics based on their profile data.

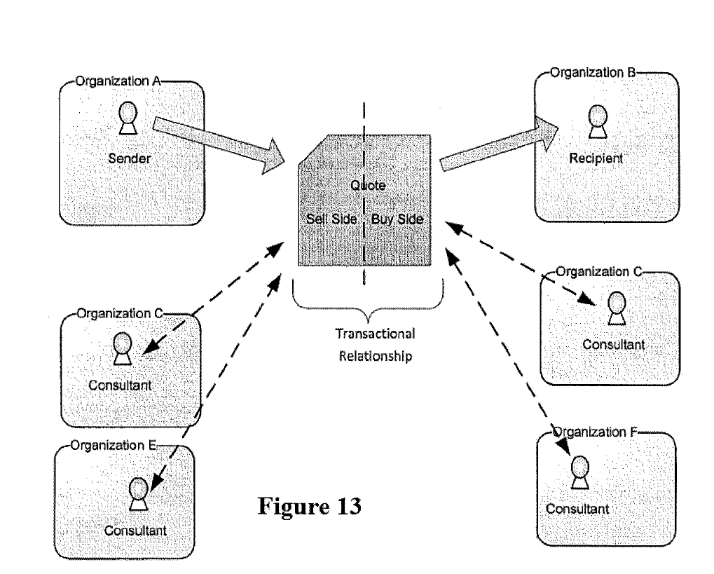

Another type of functionality that could be provided in some implementations to assist in making business decisions is support for various types of sharing. To illustrate, consider an object stored in a database which represents some kind of transaction (i.e., a “transaction object”) having a buy side and a sell side. Such an object could represent data like a quote, a catalog, an offer, and order, or a store. In order to help make a decision regarding the underlying transaction (e.g., whether to accept a quote), an electronic commerce system can designate one entity on each side of the transaction as the object's owner. On the selling side, the owner can be the user who created the object, while on the buying side, the owner can be the user who received the object. These owners can then be allowed to provide invitations to other users to provide comments or other input on the object (e.g., whether a quote looks like it should be accepted). These invitations can be sent to individuals in the same organization as the owner (e.g., co-workers of a purchasing agent), or can be in different organizations (e.g., consultants). As shown in FIG. 13, such sharing can happen on both sides of the transaction, so that the relevant decision makers can be fully informed before making a commitment.

Additionally (or alternatively), in some implementations, an electronic commerce system [110] can facilitate the gathering and analysis of feedback and reputation data associated with one or more sellers [120a-c], one or more buyers [130a-c], and/or one or more products or services. The electronic commerce system [110] can also facilitate the gathering and analysis of other data associated with one or more sellers [120a-c], buyers [130a-c], and/or individual users. By way of non-limiting example, the electronic commerce system [110] can assist SELLER₁ [120a] in gathering and analyzing feedback and reputation data. This information might be used by SELLER₁ [120a] to make more informed business decisions such as how a particular product is performing, general customer consensus, geographic areas in which to expand or contract product offerings, and/or any other business decisions which may benefit from having analyzed feedback and reputation data.

Analyzed feedback and reputation data can be provided to one or more sellers [120a-c] and/or buyers [130a-c] in a variety of manners. For example, in some implementations, an electronic commerce system [110] could gather feedback separately for products sold by an entity, and for services related to those products, thereby providing more fine grained detail than might be available for feedback based only on overall satisfaction. Additionally, in some implementations, specific information can be captured about a transaction, such as whether the product delivered corresponded to the description of the product provided by the seller, and whether the product was delivered on time. In some implementations, this type of feedback and/or reputation data could be summarized for each buyer, seller, or user having a virtual social and/or business connection [360] (as illustrated in FIG. 3) with a particular user. Summarized feedback and/or reputation data can be provided to one or more sellers [120a-c], buyers [120a-c], and/or individual users in the form of a dashboard view, computer desktop widget or gadget, or any other appropriate mechanism of providing summarized data in an accessible form. In examples of electronic commerce system [110], the dashboard view can be customized based on preferences, profile settings, account subscription level, and/or any other acceptable criterion associated with a particular buyer, seller, or user.

Of course, simply providing such information, whether via a dashboard or other mechanism, is not the only use which could be made of it. For example, in some implementations, an electronic commerce system could analyze the feedback data, and, based on that analysis, make suggestions of how an entity could provide better products and/or services to its customers. As a concrete illustration of this, in an implementation which gathers information on whether products are delivered in a timely manner, if a trend develops that delivery time is becoming more erratic, the electronic commerce system can suggest a service provider that could address that problem, such as a new delivery service. If the suggestion is accepted, the electronic commerce system could collect some kind of fee or percentage from subsequent transactions from the entity which was recommended.

It is also possible that an electronic commerce system could provide an easy way to respond to such recommendations. For example, in some implementations, an interface provided by the electronic commerce system to manage a store could include a tool which would allow the service providers responsible for delivery of items purchased in the store to be easily switched out, such as selecting a radio button corresponding to the preferred service provider. Similar approaches could be taken for other types of supporting service providers, such as payment tools (e.g., providing radio buttons for PayPal, as well as competing providers). Alternatively, in some implementations, rather than suggesting a new service provider, the electronic commerce system could issue a message to the service provider itself, indicating that it might be beneficial to promote its services to the appropriate product distributor. Of course, it is possible that these alternative options could co-exist in some implementations, such as could be the case where a user could set preferences indicating how (and whether) the electronic commerce system should react to feedback data. As a result, the disclosure set forth above should be understood as being illustrative only, and should not be treated as limiting on possible systems which could be implemented using the technology disclosed herein.

Feedback and reputation data may be gathered from a variety of sources. For instance, feedback and reputation data may be gathered from one or more buyers [130a-c] conducting B2B transactions via the system [110]. The system [110] can provide the one or more buyers [130a-c] with the ability to rank or otherwise score one or more products or sellers [120a-c] associated with a particular B2B transaction. The one or more buyers [130a-c] can rank or otherwise score the one or more products or sellers [120a-c] via an interface, prompt, field, wizard, form, or any other appropriate mechanism of providing feedback. For example, the system [110] can provide an interface which prompts BUYER₁ [130a] to leave feedback for SELLER₁ [120a] after purchasing one or products via a B2B transaction. Of course, even in implementations in which reputation information based on past transactions is made publicly available, the identity of one or more buyers [130a-c] and/or customers who purchase products and/or conduct transactions with a particular seller can be protected. The electronic commerce system can prevent a particular seller's competitors from directly or indirectly accessing customer lists or virtual social and/or business connections [360] (as indicated in FIG. 3). Additionally or alternatively, the system [110] can redact or otherwise scrub publically accessible data to ensure that the source's identity cannot be determined by anyone other than the intended party. For instance, in a non-limiting example, system [110] can prevent SELLER₂ [120b] from accessing SELLER₁'s [120a] virtual social and/or business connections [360] (as indicated in FIG. 3). In other examples, system [110] can remove BUYER₁'s [130a] identity from feedback left for SELLER₁ [120a] after a B2B transaction has been conducted. As a result, SELLER₂ [120b] can be prevented from indirectly learning that BUYER₁ [130a] is a customer of SELLER₁ [120a].

Additionally or alternatively, feedback and reputation data may be gathered from one or more average customers conducting B2C transactions. The electronic commerce system [110] can gather B2C feedback information from user posts or transmissions left by average customers on the Internet. For instance, the electronic commerce system [110] can gather B2C feedback information from popular social and business networking websites, blogs, chat groups, and/or any other Internet medium providing a place for customers to comment on products or services.

As disclosed above, the electronic commerce system [110] can also facilitate B2C commerce. For example, in some implementations, one or more sellers [120a-c] can generate a virtual storefront that provides customers who are not affiliated with an organization with a location to directly purchase products, learn about product offerings, and/or leave feedback regarding a particular product or seller. For instance, SELLER₁ [120a] can generate a virtual storefront to advertise and sell products directly to average consumers. Such consumers could be allowed to access the virtual storefront and leave feedback for SELLER₁ [120a] regarding one or more products or services. This feedback information can be analyzed by the system [110] and provided to SELLER₁ [120a]. In some implementations, an electronic commerce system [110] could support creation of virtual storefronts as stand-alone websites and/or might support the inclusion of such storefronts in third party websites (e.g., social networking websites such as LinkedIn or Facebook), such as using the techniques discussed above in the context of FIGS. 6 and 7.

Also, in some cases, an electronic commerce system [110] could be implemented to facilitate consumer based transactions, such as B2C2C or C2C transactions. For example, consider a case where an electronic commerce system [110] allows businesses to set up stores on third party websites, such as Facebook. In such a case, the system could be configured so that, when a consumer purchases a product through the store, that consumer could be given the option to have a store automatically set up a website of his or her choosing (e.g., by establishing a catalog feed to the consumer's Facebook page, by adding a flash item to the user's wall, etc) where other consumers could purchase the same item which the consumer had purchased from the original vendor. This type of viral store creation could further be supported by various types of incentive schemes. For example, the original vendor could allocate a portion of the normal price of a product to providing rebates or coupons to consumers who sell products through their own automatically created stores. This type of incentive and automatic store creation could also be extended recursively. That is, a second consumer who purchases a product from a store which was automatically set up for the first consumer could themselves indicate that they wished to create a store, and rebates or other incentives could be distributed between the first and second consumers so that the consumers would have incentives to both sell products and to encourage others to sell the products as well.

Also, in some implementations, an electronic commerce system [110] could include functionality to allow sellers to offer specific discounts to one or more of their buyers. Discounts can be specific to a particular buyer or a particular product offered by a particular seller. The amount and frequency of discounts can be a function of the identity of the buyer, a quantity of B2B or B2C transactions conducted with a particular buyer or customer, historical discount usage patterns associated with a particular buyer, and/or any other appropriate subjective or objective criteria for determining the amount and frequency of a discount offer. Additionally or alternatively, a particular seller can offer customized discounts to one or more of the buyers [130a-c]. For instance, in one non-limiting example of the electronic commerce system [110], SELLER₁ [120a] can offer a discount only to BUYER₁ [130a] and not to BUYER₂ [130b]. Additionally or alternatively, SELLER₁ [120a] can offer a greater discount to BUYER₁ [130a] than one offered to BUYER₂ [130b]. Different permutations and combinations of discounts are possible with the electronic commerce system [110]. Also, in some cases, such discounts would not necessarily be explicitly advertised or identified to the buyers. Instead, discounts offered by a particular seller might be automatically incorporated into the price of one or more products offered by the seller. Upon receiving either a copy of the catalog [245a] or a catalog feed [245b] associated with a seller, a buyer will be provided with one or more products prices that already reflect any discounts being offered.

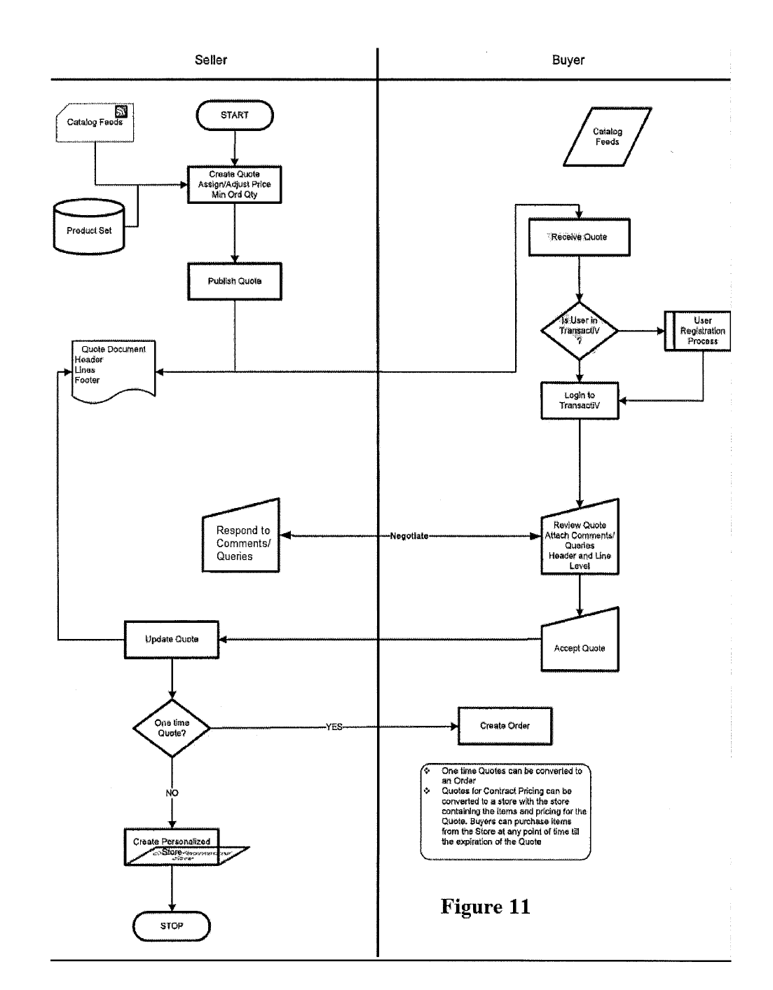

Further, in some implementations, an electronic commerce system [110] could include functionality which would facilitate sellers soliciting and responding to requests for quotes. For example, there could be an option which would allow a seller to post a catalog (or portions or a summary thereof) without prices, and provide a link which potential buyers could use to send requests for quotes (for example, by using a shopping cart feature to indicate the products that a quote is desired on, or by indicating an interest in a quote on the catalog as a whole). The sellers could then automatically respond to those requests for quotes by having the electronic commerce system [110] send copies of the seller's catalog to the buyers, potentially accompanied by some standard (e.g., 20% premium) modification to the catalog item prices. Similarly, in some cases the electronic commerce system [110] could match the profiles of the potential buyers against the seller's catalog, thereby automatically generating a request for quote response which is tailored to a specific potential buyer. An illustrative sequence of events in an interaction between a buyer and a seller which could take place in creating and accepting a quote is illustrated in FIG. 11.

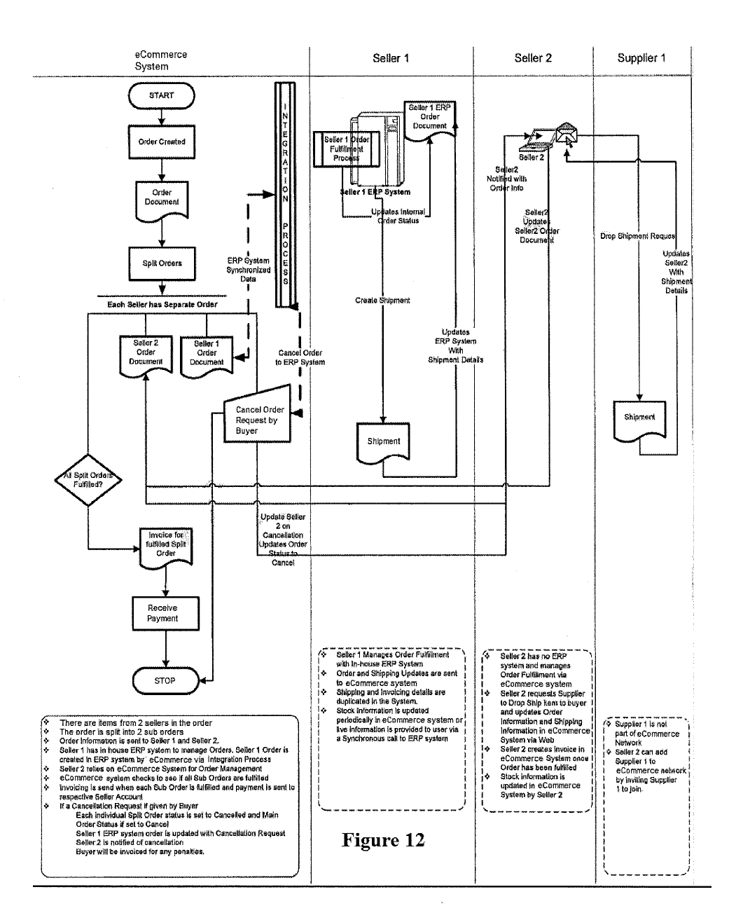

Other types of back end optimizations could also be supported. For example, in some cases, when a product is purchased using the electronic commerce system [110], the electronic commerce system [110] might use information associated with the entity selling that product to automatically create an order with that entity's supplier to restock (and/or deliver) the product which had been sold. As shown in FIG. 12, this could even take place in situations where a customer places an order from stores of multiple sellers having different back end systems. Similar types of supply chain management functions (e.g., identifying efficient routes for delivery and product storage, etc) could also be preformed by the electronic commerce system [110] in various implementations. Accordingly, the discussion of functionality set forth above should be understood as being illustrative only, and not limiting.

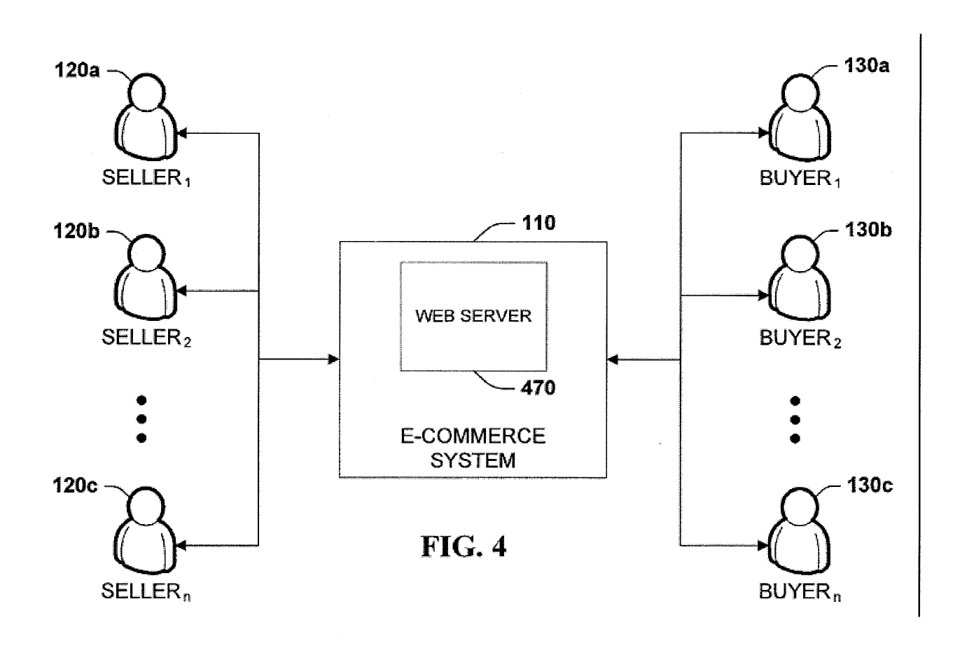

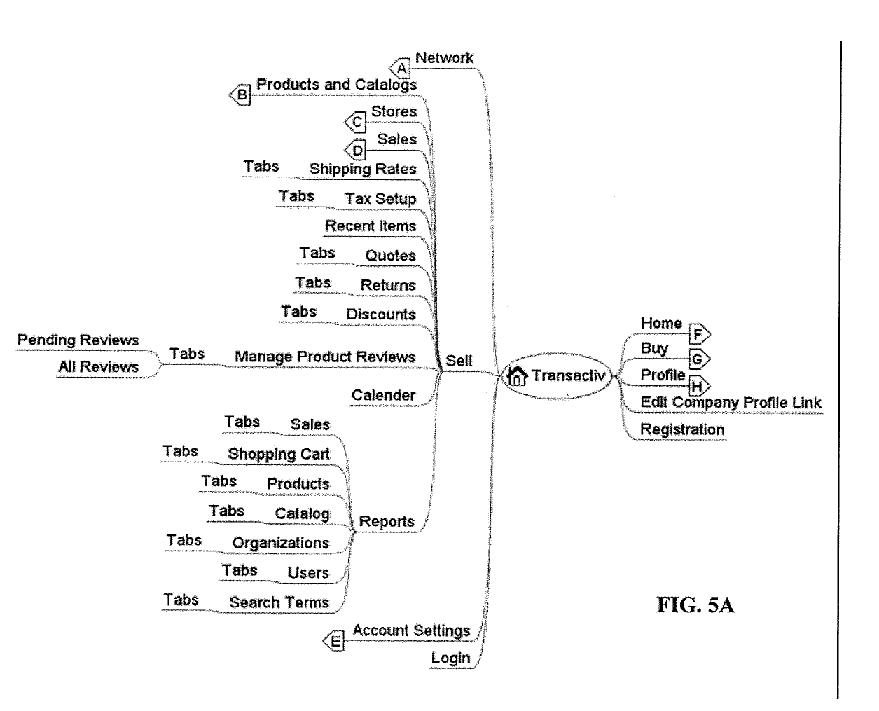

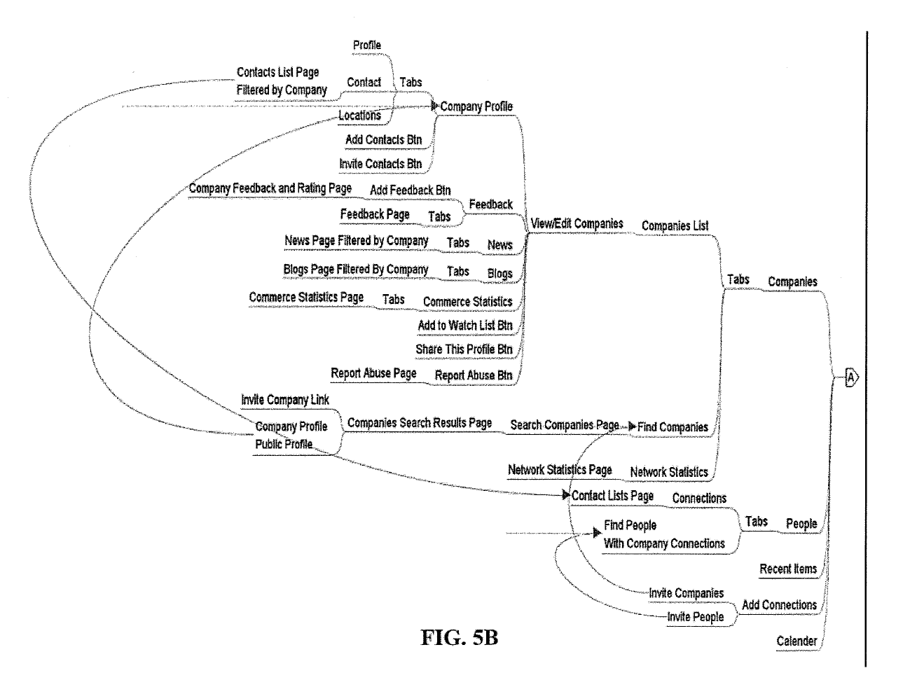

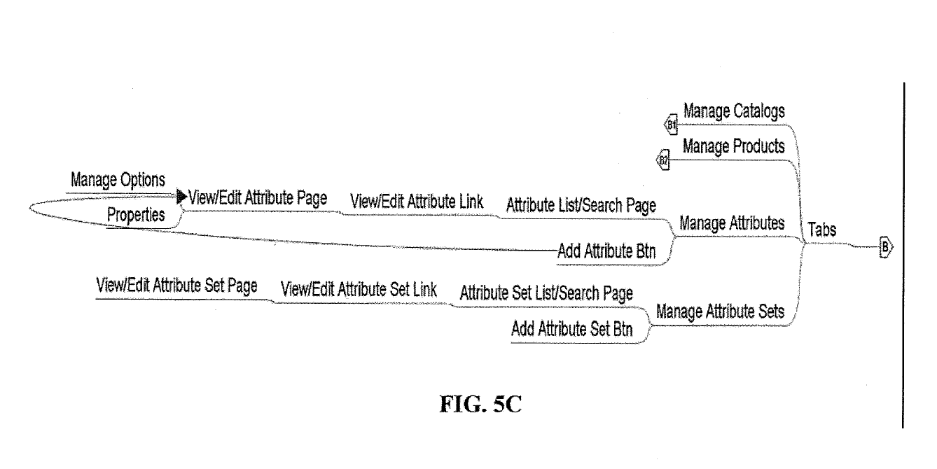

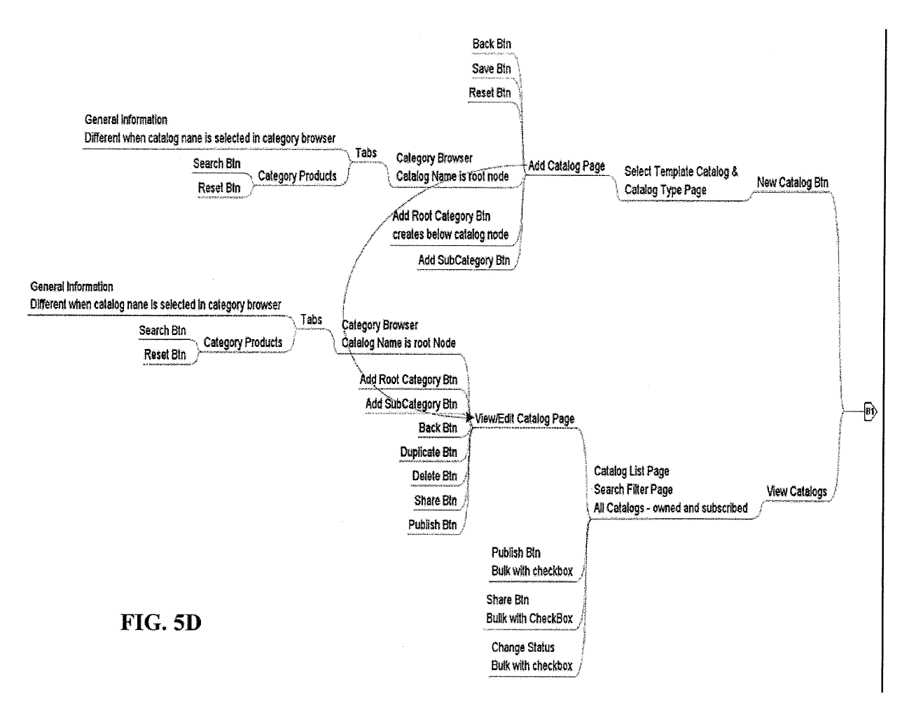

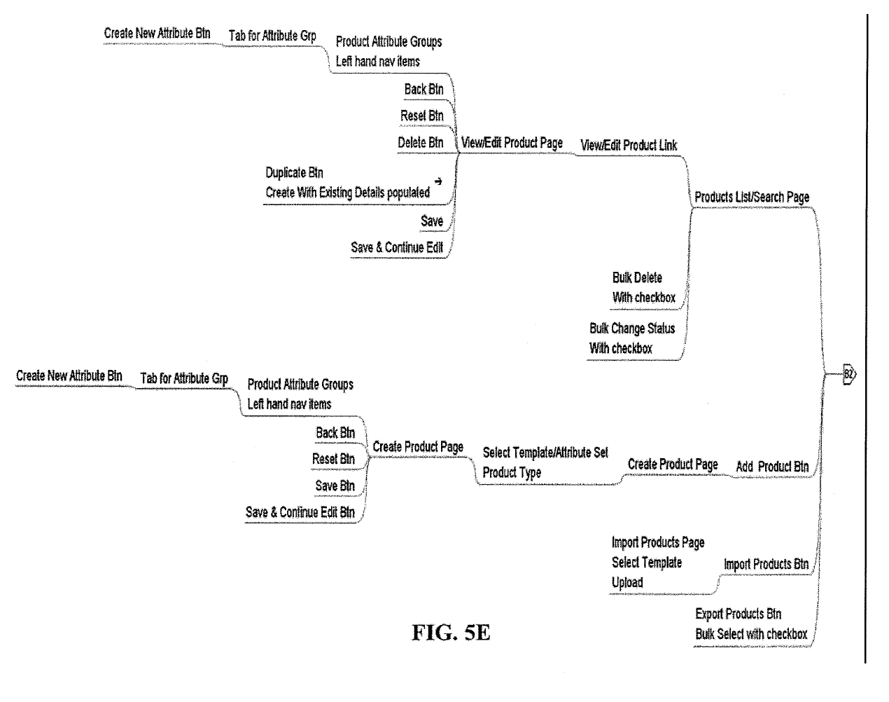

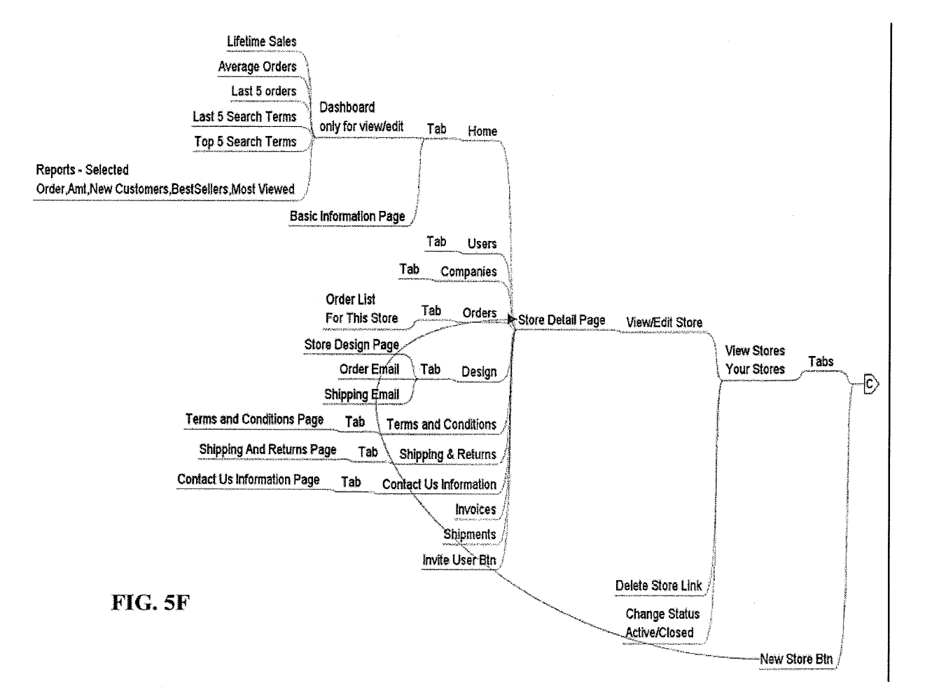

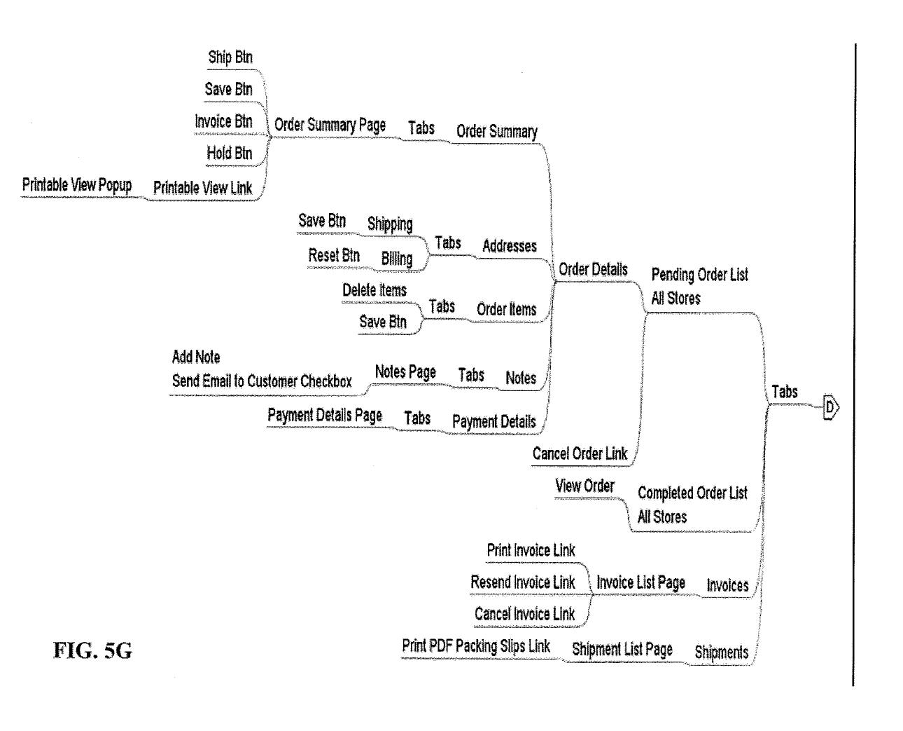

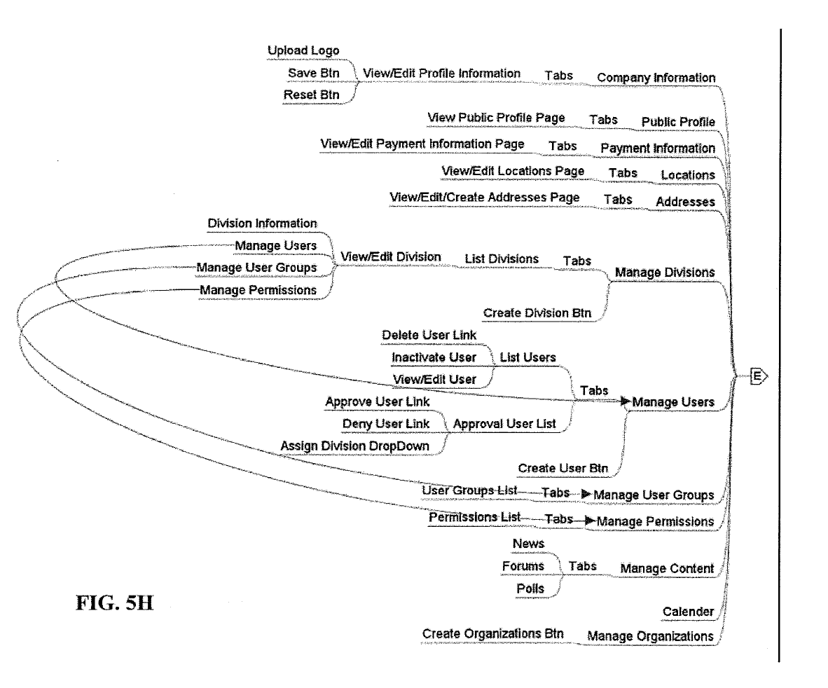

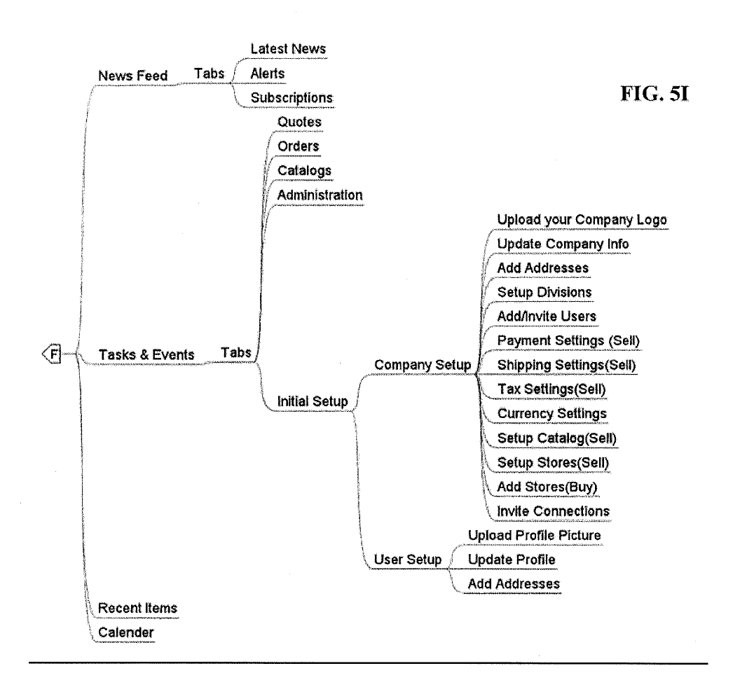

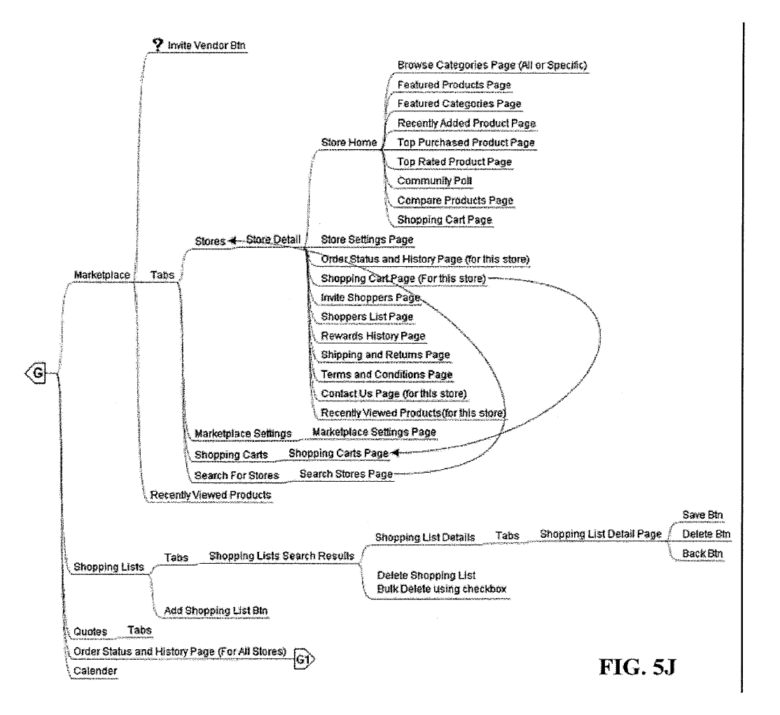

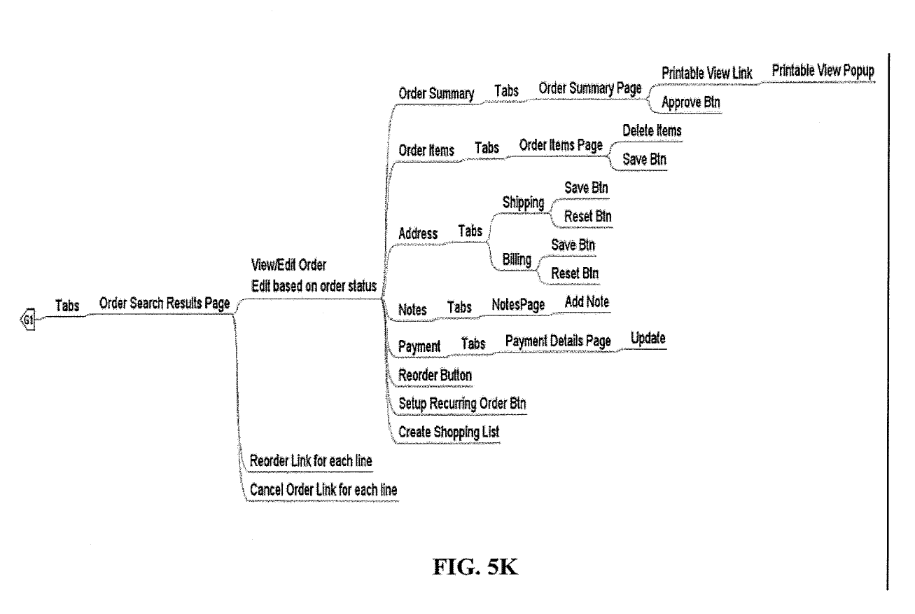

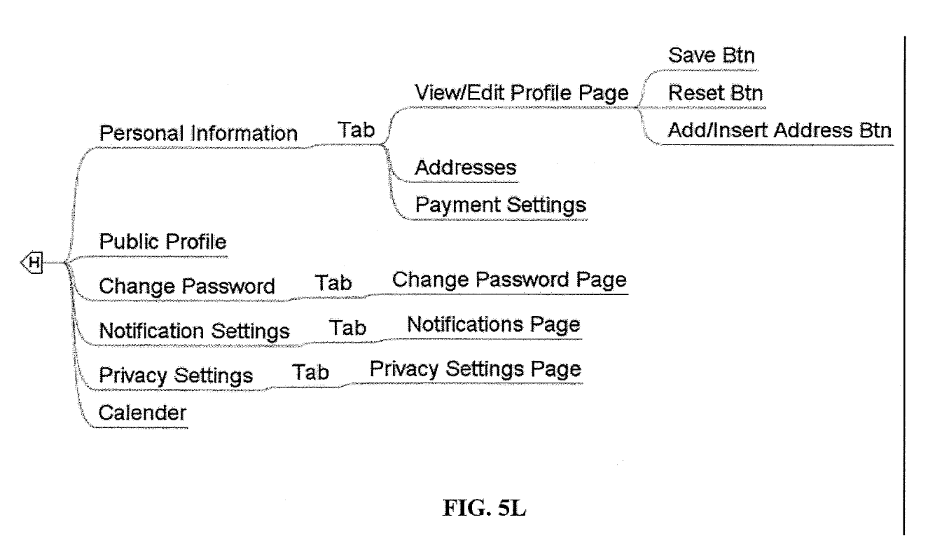

Turning to FIG. 4, an example of an electronic commerce system [110] comprising a web component [470] is illustrated. Such a web component [470], which could be structured as illustrated in FIGS. 5A-5L, can facilitate B2B and/or B2C transactions between one or more sellers [120a-c], buyers [130a-c], and/or individual users or customers. One or more web pages can be provided by the web server to conduct B2B and/or B2C transactions or interactions. The one or more web pages can comprise one or more HyperText Markup Language (“HTML”) pages, Active Server Pages (“ASP”), Personal Home Pages/Php: Hypertext Preprocessor Pages (“PHP”), and/or pages utilizing any other appropriate web-based protocol.

In implementations of the disclosed subject matter, information associated with any or all implementations of the electronic commerce system [110] can be stored in one or more data repositories, data warehouses, databases, or the like. For instance, data associated with the one or more electronic catalogs [240a-c], copies of electronic catalogs [245a], and catalog feeds [245b] can be stored within one or more data repositories. Additionally or alternatively, account data, profile data, B2B/B2C transaction history data, product data, feedback and reputation data, interfaces, session caches, and/or any other data utilized to facilitate B2B and/or B2C transactions and interactions can be stored in the one or more data repositories. Similarly, the electronic commerce system [110] itself can be deployed as software, hardware, or a combination of hardware and software. When deployed as software, or a combination of hardware and software, the electronic commerce system comprises one or more computer-executable instructions stored on a computer-readable storage medium, that when executed by a processor perform the functionality and acts disclosed above.

Additionally or alternatively, as illustrated in FIG. 1, implementations of the electronic commerce system can be deployed as single component, two or more individual components, or any combination thereof. For instance, the electronic commerce system can be deployed as a single component that provides the functionality disclosed above, or it can be deployed as two or more sub- components, for instance one or more web components, database components, application server components, Graphical User Interface (“GUI”) components, and/or any other appropriate component for providing the above functionality.

In some implementations of the electronic commerce system [110], all components and functionality can be provided by a single specialized server or by multiple specialized servers in communication with each other. Additionally or alternatively, in examples of the electronic commerce system [110], the one or more sellers [120a-c], one or more buyers [130a-c], and/or any hardware or software components can utilize one or more communication networks to facilitate B2B and/or B2C commerce. For instance, both wired and wireless implementations of communication networks such as local area networks (“LAN”), wide area networks (“WAN”), metropolitan area networks (“MAN”), and/or any other appropriate form of communicating data can be utilized by all of or a portion of the electronic commerce system [110].

While this disclosure has set forth various specific implementations, architectures, functions and benefits for systems that can be used to facilitate electronic commerce using the inventors' technology, it should be understood that the disclosure set forth herein is not limited to being implemented in the manners explicitly described. Accordingly, instead of limiting the protection accorded by this document, or by any document which is related to this document, to the material explicitly disclosed herein, the protection accorded by this or any related document should be understood to be defined by the claims in such related documents, when the terms used in those claims which are listed under an “Explicit Definitions” heading are given their explicit definitions, and the remaining terms are given their broadest reasonable interpretation as shown by a general purpose dictionary. To the extent that the interpretation which would be given to any claims based on this disclosure is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in (or conclusions drawn from) this disclosure shall have no effect.

We claim:

1. A system comprising an electronic commerce system, wherein the electronic commerce system is configured to facilitate interactions between one or more buyers and one or more sellers, and wherein the electronic commerce system is configured to allow one or more users of the electronic commerce system to provide one or more invitations to enter into transactions with, or create an account in, the electronic commerce system.

2. A method comprising:
a) logging into an electronic commerce system;
b) sending an invitation from a first user to an entity to participate in an interaction via the electronic commerce system;
c) storing data associating the first user and the entity in the electronic commerce system based on the invitation.

3. A method comprising:
a) adding an interface application to a network location, wherein the interface application is configured to, in response to a user accessing the network location using a user computer, send a request for a set of storefront data to a server located remotely from the user computer;
b) via an interface provided by the server located remotely from the user computer, selecting a store for publication; and
c) sending a message to the server located remotely from the user computer indicating that the store should be published at the network location;
whereby the store is made accessible such that purchases from the store can be made by the user at the network location by performing steps capable of completion by a single individual in less than ten minutes.
